(19) United States
(12) Patent Application Publication
(10) Pub. No.: US 2005/0286632 A1
(43) Pub. Date: Dec. 29, 2005

(54) Efficient motion -vector prediction for unconstrained and lifting-based motion compensated temporal filtering

(75) Inventors: Mihaela Van Der Schaar, Ossining, NY (US); Deepak Turaga, Croton-On-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/530,265

(22) PCT Filed: Sep. 24, 2003
(86) PCT No.: PCT/IB03/04291

§ 371 Date: Apr. 5, 2005

Related U.S. Application Data
(60) Provisional application No. 60/416,592, filed on Oct. 7, 2002.
(60) Provisional application No. 60/483,795, filed on Jun. 30, 2003.

(51) Int. Cl. H04B 1/66; H04N 11/02; H04N 11/04; H04N 7/12

(52) U.S. Cl. 375/240.16; 375/240.12

(57) ABSTRACT

Video coding method and device for reducing the number of motion vector bits, the method and device differentially coding the motion vectors at each temporal decomposition level by predicting the motion vectors temporally and coding the differences.

This application claims the benefit under 35 USC 119(e) of U.S. provisional application Ser. No. 60/416,592, filed on Oct. 7, 2002, which is incorporated herein by reference.

The present invention relates generally to video coding, and more particularly, to wavelet based coding utilizing differential motion vector coding in unconstrained and lifting-based motion compensated temporal filtering.

Unconstrained motion compensated temporal filtering (UMCTF) and lifting-based motion compensated temporal filtering (MCTF) are used for motion-compensated wavelet coding. These MCTF schemes use similar motion compensation techniques, e.g. bi-directional filtering, multiple reference frames etc., to eliminate the temporal correlation in the video. Both UMCTF and lifting-based MCTF, outperform uni-directional MCTF schemes.

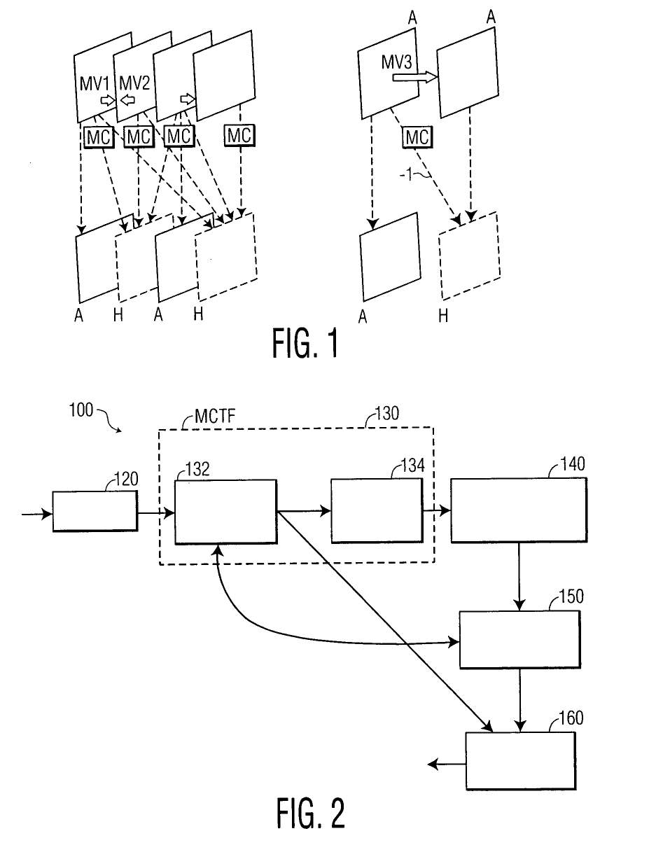

In providing good temporal decorrelation, UMCTF and lifting-based MCTF have the disadvantage of requiring the transmission of additional motion vectors (MVs), which all need to be encoded. This is demonstrated in FIG. 1, which shows an example of UMCTF without multiple reference frames, but with only bi-directional filtering. As can be seen, the MVs in each of the temporal decomposition levels (MV 1 and MV 2 in level 0 and MV3 in level 1) are independently estimated and encoded. Since bi-directional motion estimation is performed at multiple temporal decomposition levels, the number of additional MVs bits increases with the number of decomposition levels. Similarly, the larger the number of reference frames used during temporal filtering, the greater the number of MVs that need to be transmitted. Compared to a hybrid video coding scheme or to a Haar temporal decomposition, the number of MV fields is almost double. This can negatively affect the efficiency of UMCTF and lifting-based MCTF for bi-directional motion-compensated wavelet coding at low transmission bit-rates.

Accordingly, a method is needed which reduces the number of bits spent for coding MVs in an unconstrained or lifting-based MCTF scheme.

The present invention is directed to methods and devices for coding video in a manner that reduces the number of motion vector bits. According to the present invention, the motion vectors are differentially coded at each temporal decomposition level by predicting the motion vectors temporally and coding the differences.

FIG. 1 shows an example of UMCTF without multiple reference frames, but with only bi-directional filtering.

FIG. 2 shows an embodiment of an encoder which may be used for implementing the principles of the present invention.

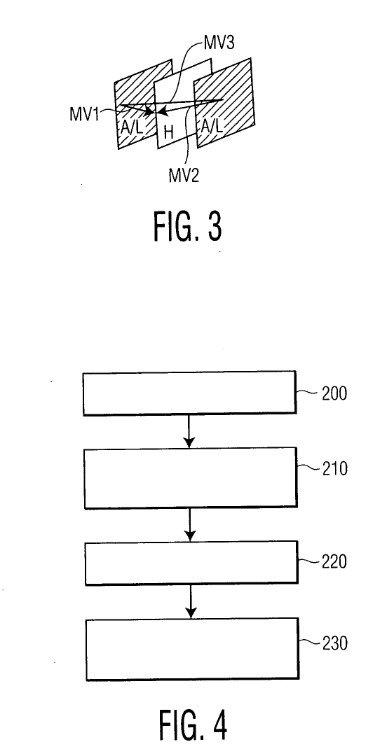

FIG. 3 shows an exemplary GOF which considers three motion vectors, at two different temporal decomposition levels.

FIG. 4 is a flow chart showing a top down prediction and coding embodiment of the method of the present invention.

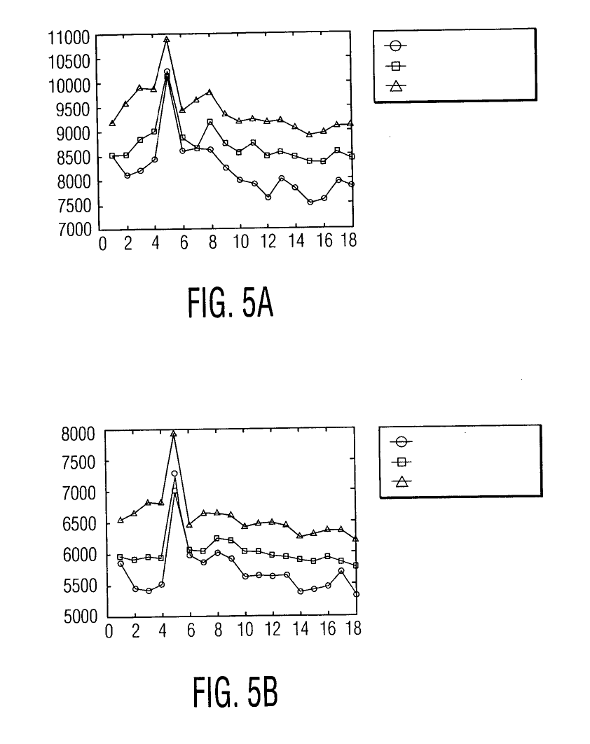

FIGS. 5A, 5B, 6A, 6B, and 7 show results for two difference video sequences using the top down prediction and coding embodiment of the method of the present invention.

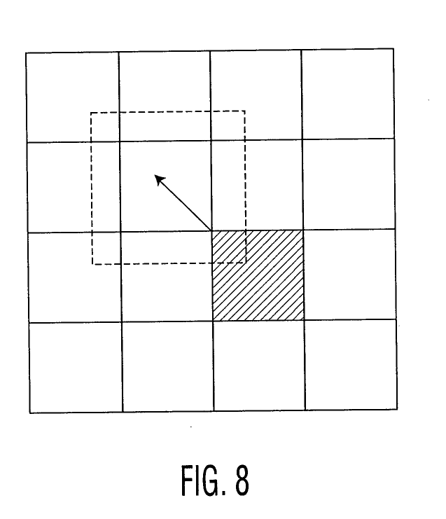

FIG. 8 shows an example of top down prediction during motion estimation.

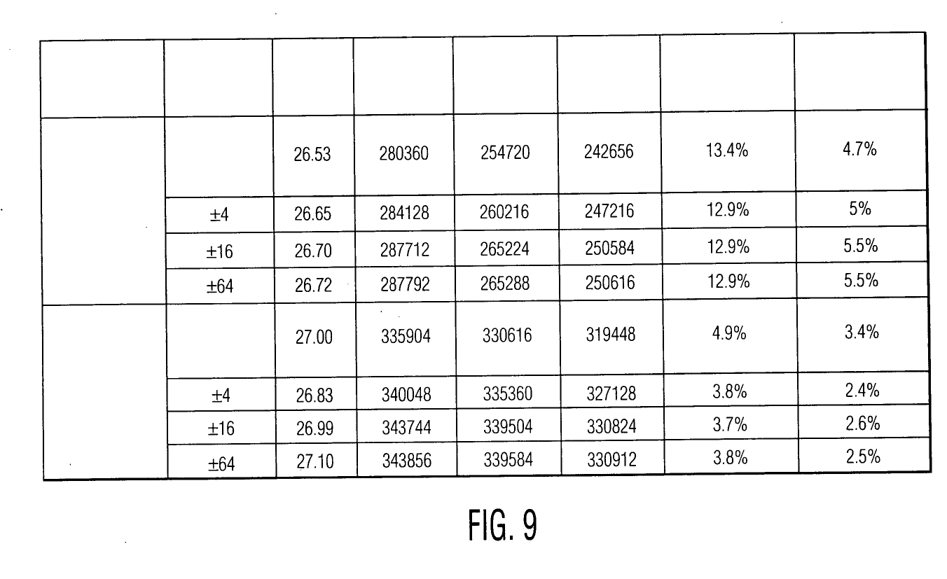

FIG. 9 shows results for two difference video sequences using the top down prediction during motion estimation.

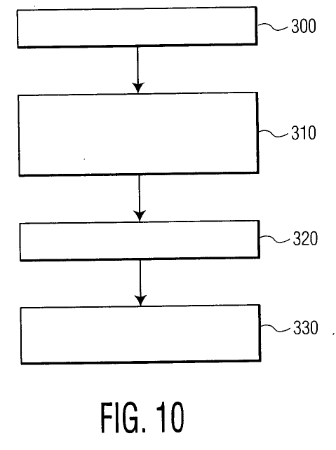

FIG. 10 is a flow chart showing a bottom up prediction and coding embodiment of the method of the present invention.

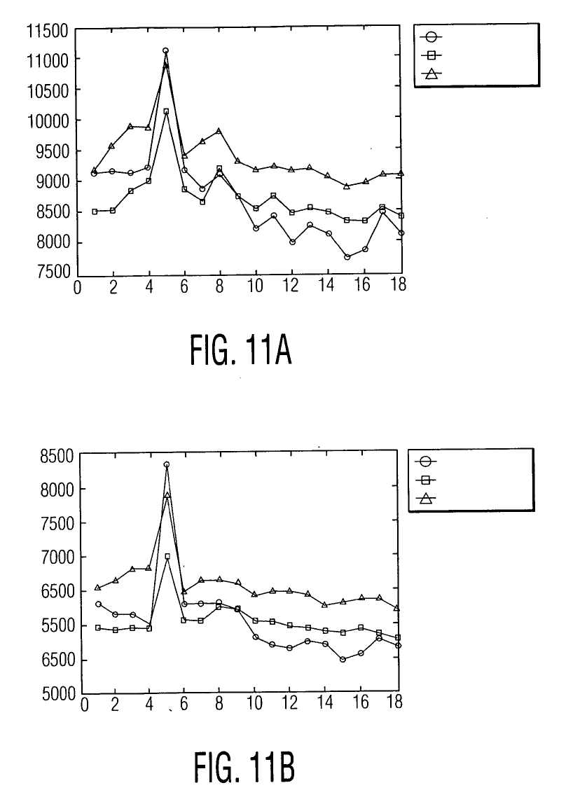

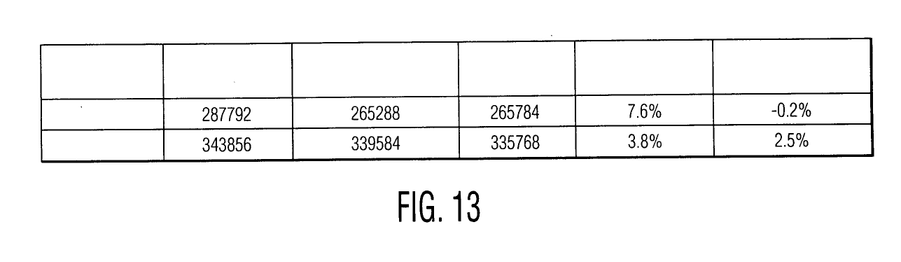

FIGS. 11A, 11B, 11A, 11B, and 13 show results for two difference video sequences using the bottom up prediction and coding embodiment of the method of the present invention.

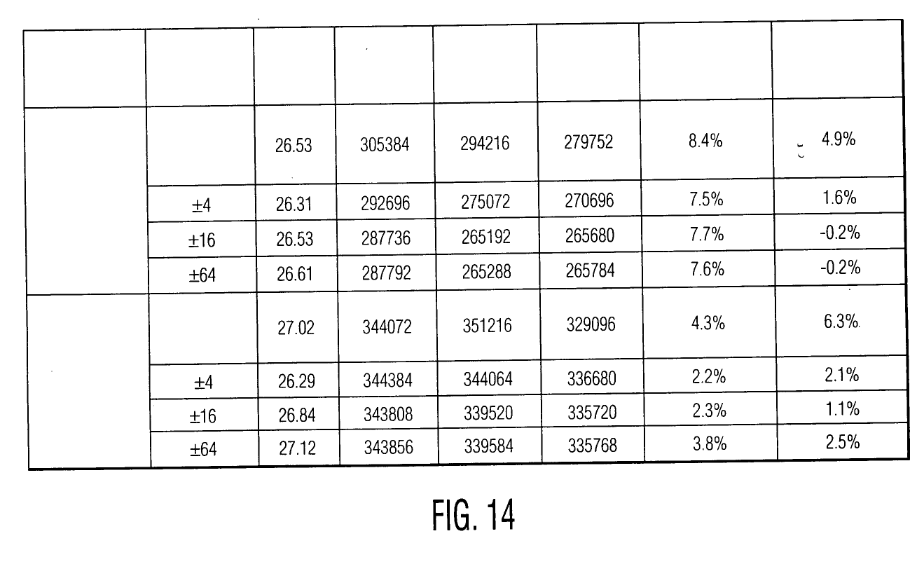

FIG. 14 shows results for two difference video sequences using the top down prediction during motion estimation.

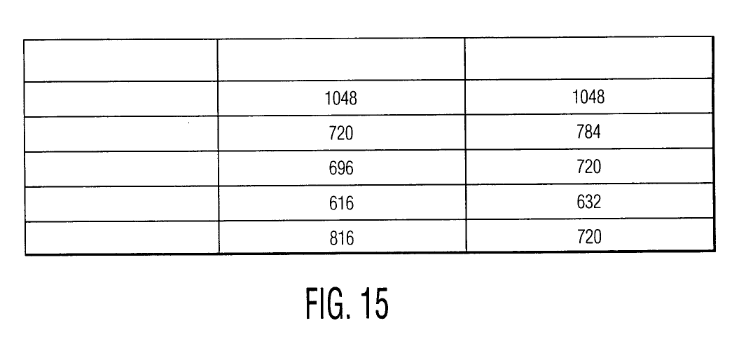

FIG. 15 shows motion vector bits for frame within a group of frames using the top down prediction during motion estimation.

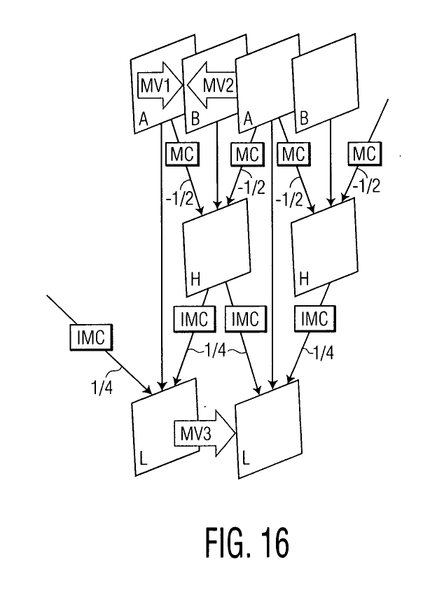

FIG. 16 shows two levels of bi-directional MCTF with lifting.

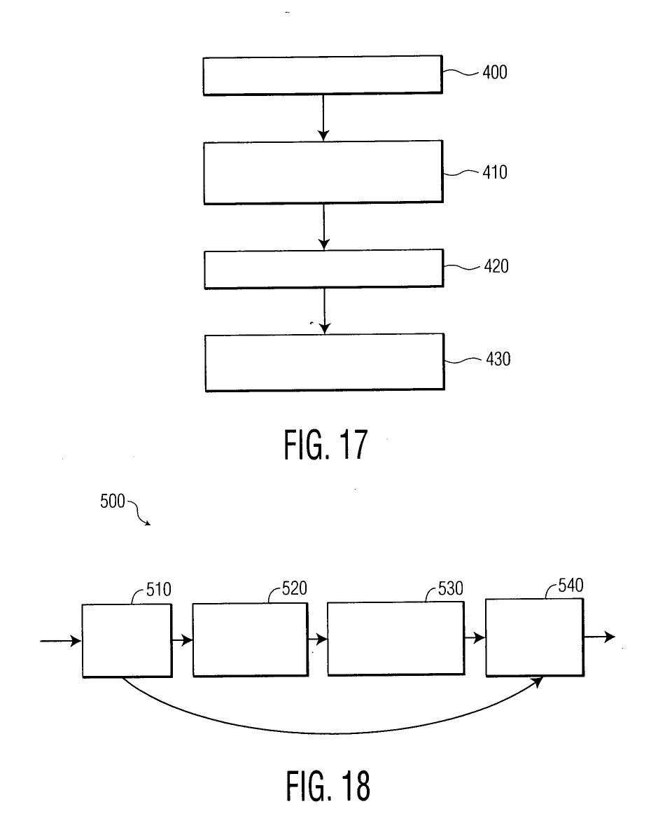

FIG. 17 shows a mixed, hybrid prediction and coding embodiment of the method of the present invention.

FIG. 18 shows an embodiment of a decoder which may be used for implementing the principles of the present invention.

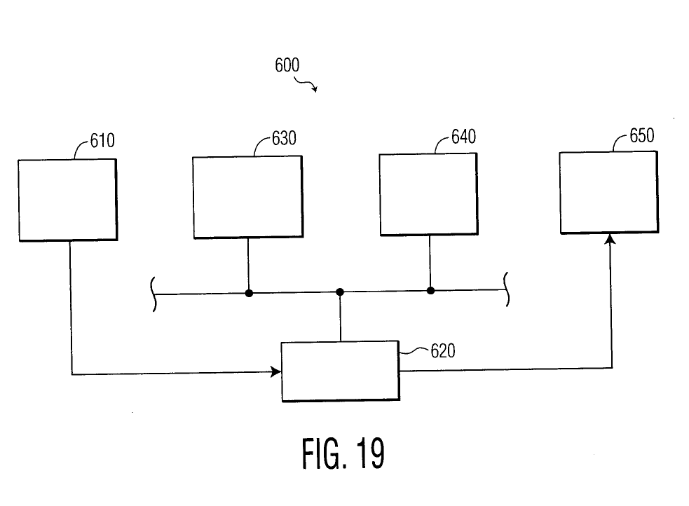

FIG. 19 shows an embodiment of a system in which the principles of the present invention may be implemented.

The present invention is a differential motion vector coding method, which reduces the number of bits needed for encoding motion vectors (MVs) generated during unconstrained and lifting-based motion compensated temporal filtering for bi-directional motion-compensated wavelet coding. The method encodes the MVs differentially at the various temporal levels. This is generally accomplished by temporally predicting the MVs and encoding the differences using any conventional encoding scheme.

FIG. 2 shows an embodiment of an encoder which may be used for implementing the principles of the present invention, denoted by numeral 100. The encoder 100 includes a partitioning unit 120 for dividing an input video into a group of frames (GOFs), which are encoded as a unit. An unconstrained or lifting-based MCTF unit 130 is included that has a motion estimation unit 132 and a temporal filtering unit 134. The motion estimation unit 132 performs bi-directional motion estimation or prediction on the frames in each GOF according to the method of the present invention, as will be explained in detail further on. The temporal filtering unit 134 removes temporal redundancies between the frames of each GOF according to the motion vectors MV and frame numbers provided by the motion estimation unit 132. A spatial decomposition unit 140 is included to reduce the spatial redundancies in the frames provided by the MCTF unit 130. During operation, the frames received from the MCTF unit 130 may be spatially transformed by the spatial decomposition unit 140 into wavelet coefficients according to a 2D wavelet transform. There are many different types of known filters and implementations of the wavelet transform. A significance encoding unit 150 is included to encode the output of the spatial decomposition unit 140 according to significance information, such as the magnitude of the wavelet coefficients, where larger coefficients are more significant than smaller coefficients. An entropy encoding unit 160 is included to produce the output bit-stream. The entropy encoding unit 160 entropy encodes the wavelet coefficients into an output bit-stream. The entropy encoding unit 160 also entropy encodes the MVs and frame numbers provided by the motion estimation unit 130 according to the method of the present invention, as will be explained in detail further on. This information is included in the output bit-stream in order to enable decoding. Examples of a suitable entropy encoding technique include without limitation arithmetic encoding and variable length encoding.

The differential motion vector encoding method will now be described with reference to the GOF of FIG. 3, which for simplicity of description only, considers three motion vectors, at two different temporal decomposition levels, which may be called level 0 and level 1. MV1 and MV2 are the bi-directional motion vectors connecting an H-frame (the middle frame) to a previous A-frame (the left A-frame) and a proceeding A-frame (the right A-frame) at temporal decomposition level 0. After filtering at this temporal decomposition level, the A-frames are then filtered at the next temporal decomposition level, i.e., level 1, wherein MV3 corresponds to the motion vector connecting these two frames.

In accordance with a top down prediction and coding embodiment of the method of the present invention, the steps of which are shown in the flow chart of FIG. 4, the MVs at level 0 are used to predict the MVs at level 1 and so on. Using the simplified example of FIG. 3, step 200 includes determining MV1 and MV2. MV1 and MV2 may be determined conventionally by the motion estimation unit 132, at level 0 during motion estimation. During motion estimation, groups of pixels or regions in the H-frame are matched with similar groups of pixels or regions in the previous A-frame to obtain MV1, and groups of pixels or regions in the H-frame are matched with similar groups of pixels or regions in the proceeding A-frame to obtain MV2. In step 210, MV3 is estimated or predicted for level 1 as a refinement based on MV1 and MV2. The estimation for MV3 is an estimation of the groups of pixels or regions in the proceeding A-frame from level 0, which match similar groups of pixels or regions in the previous A-frame from level 0. The estimation or prediction of MV3 may be obtained by calculating the difference between MV 1 and MV2. In step 220, the entropy encoding unit 160 (FIG. 2) entropy encodes MV1 and MV2. The method may end here or optionally in step 230, the entropy encoding unit 160 may also encode refinement for MV3.

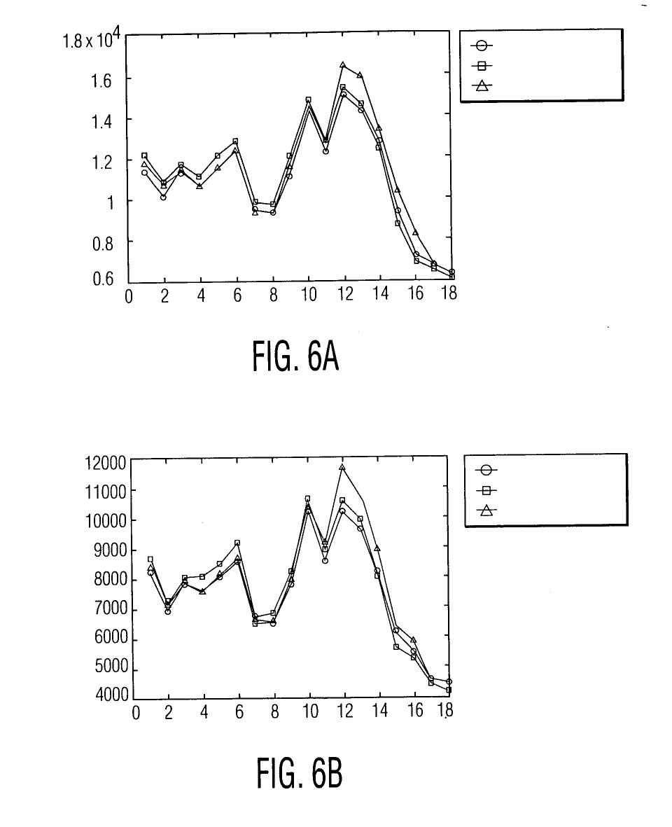

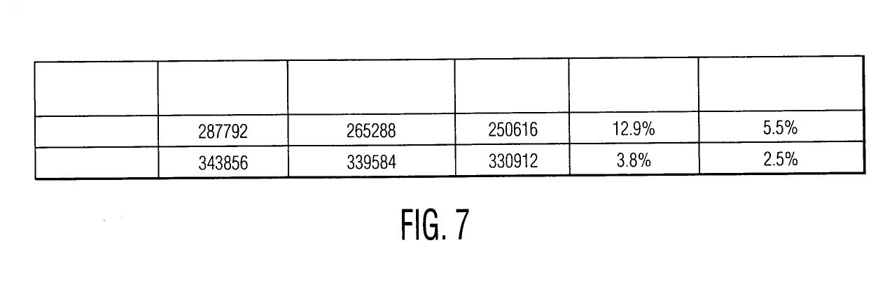

Since MV 1 and MV2 are likely to be accurate (due to the smaller distance between the frames), the prediction for MV3 is likely to be good, thereby leading to increased coding efficiency. Results for two difference video sequences are shown in FIGS. 5A, 5B, 6A, and 6B. Both sequences are QCIF at 30 Hz. A GOF size of 16 frames, a four level temporal decomposition, and a fixed block size of 16×16, and a search range of ±64 were used in these examples. The results present the forward and backward MVs separately, and are shown across the different GOFs in the sequence, in order to highlight the content dependent nature of the results. The same graphs also plot the result of using no prediction for coding the MVs, and spatial prediction. The resulting bits needed for the coding are summarized in the table of FIG. 7.

As expected, due to the greater temporally correlated motion in the Coastguard video sequence of FIGS. 5A and 5B, there are larger savings in bits. It is important to realize the content dependent nature of these results. For instance, near the end of the Foreman video sequence of FIGS. 6A and 6B, the motion is very small, and is spatially very well correlated. This leads to very good performance by the spatial predictive coding of MVs. Also, during the sudden camera motion in the Coastguard video sequence, around GOF 5, spatial and temporal prediction of motion does not provide many gains.

Because the top down prediction and coding embodiment of the method of the present invention realizes bit-rate savings, this embodiment of the present invention may also be utilized during the motion estimation process. An example of this is shown in FIG. 8.

After considering different search range sizes after prediction it was observed that this can provide interesting tradeoffs between the bit-rate, the quality, and the complexity of the estimation. The table of FIG. 9 summarizes the results of different search-size windows around the temporal prediction location (the temporal prediction is used as the search center).

The No prediction for the ME (motion estimation) row corresponds to the results in the table of FIG. 7. As expected, due to the greater temporally correlated motion in the Coastguard video sequence, there are larger savings in MV bits. As may be seen by comparing other rows to the ‘No pred for MV’ row, temporal MV prediction during estimation helps in reducing the MV bits further. This reduction in MV bits allows more bits for the texture, and thus higher PSNR when the motion is temporally correlated. With increasing range after prediction, the quality of the matches improves, so although the bits for MV increase, the PSNR actually improves. It must be mentioned that the results vary from GOF to GOF, depending on the content and the nature of the motion. For some GOFs improvements have been observed in PSNR of up to 0.4 dB, or MV bit savings over spatial prediction of up to 12%.

One of the disadvantages of using the top down prediction and coding embodiment is the fact that all the motion vectors need to be decoded before the temporal recomposition. So MV1 and MV2 need to be decoded before MV3 can be decoded, and level 1 can be recomposed. This is unfavorable for temporal scalability, where some of the higher levels need to be decoded independently.

The top down prediction and coding embodiment may easily be used for coding MVs within the lifting framework, where motion estimation at higher temporal levels is performed on filtered frames. However the gains of differential MV coding are likely to be smaller, due to the temporal averaging used to create the L-frames. Firstly, temporal averaging leads to some smoothing and smearing of objects in the scene. Also, when good matches cannot be found, some undesirable artifacts are created. In this case, using the motion vectors between unfiltered frames to predict the motion vectors between average frames, or vice versa, might lead to poor predictions. This can cause reduced efficiency of the motion vector coding.

Referring now to the flow chart of FIG. 10, there is shown a bottom-up prediction and coding embodiment of the method of the present invention. In this embodiment, the MVs at level 1 are used to predict the MVs at level 0 and so on. Using the simplified example of FIG. 3 again, step 300 includes determining MV3. MV3 may be determined conventionally by the motion estimation unit 132, at level 1 during motion estimation. During motion estimation groups of pixels or regions in the proceeding A-frame from level 0 are matched to similar groups of pixels or regions in the previous A-frame from level 0. In step 310, MV1 and MV2 for level 0 are each estimated or predicted as a refinement based on MV3. The estimate for MV1 is an estimate of the groups of pixels or regions in the H-frame which match similar groups of pixels or regions in the previous A-frame. The estimate for MV2 is an estimate of the groups of pixels or regions in the H-frame that match similar groups of pixels or regions in the proceeding A-frame. The estimation of MV1 may be obtained by calculating the difference between MV3 and MV2. The estimation of MV2 may be obtained by calculating the difference between MV3 and MV1. In step 320, the entropy encoding unit 160 (FIG. 2) entropy encodes MV3. The method may end here or optionally in step 330, the entropy encoding unit 160 may also encode the refinements for MV1 and/or MV2.

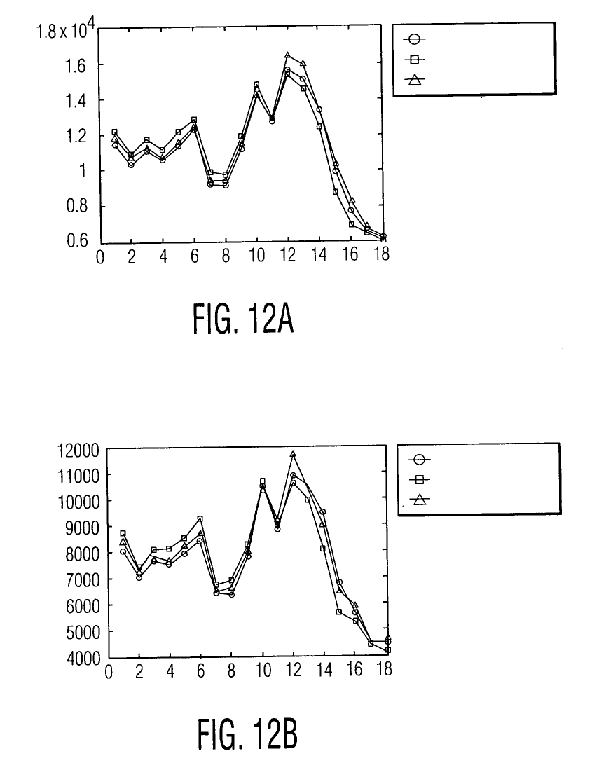

The bottom-up prediction and coding embodiment produces temporally hierarchical motion vectors that may be used progressively at different levels of the temporal decomposition scheme. So MV3 can be used to recompose Level 1 without having to decode MV2 and MV1. Also, since MV3 is now more important than MV2 and MV 1, as with the temporally decomposed frames, it may easily be combined with unequal error protection (UEP) schemes to produce more robust bitstreams. This can be beneficial especially in low bit-rate scenarios. However, the prediction scheme is likely to be less efficient than the top-down embodiment described previously. This is because MV3 is likely to be inaccurate (due to the larger distance between the source and the reference frame) and the use of an inaccurate prediction can lead to increased bits. As in the top-down embodiment, experiments were performed on the Foreman and Coastguard video sequences at the same resolutions and the same motion estimation parameters. The results are presented in FIGS. 11A, 11B, 12A, and 12B to show the gains of temporal prediction for coding alone (no prediction during motion estimation). The results of this are summarized in the table of FIG. 13.

As expected the prediction results are not as good as in the Top-down embodiment, and there is a significant degradation in performance especially for GOFs, where the motion is not temporally correlated. From FIGS. 11A and 11B, it can be seen that the temporal prediction performs extremely poorly for GOF 5 of the Coastguard video sequence. This is because around GOF 5 there is a sudden camera motion and the resulting motion has low temporal correlation. It should be reemphasize that the content dependent nature of these results, and the fact that the decision to use temporal filtering may be turned on and off adaptively.

Some of the above experiments were repeated using the bottom-up embodiment during motion estimation, the results of which are summarized in the table of FIG. 14. As can be seen, the results are not as good as the results for the top-down prediction embodiment. More interestingly, however, looking at the results for the Coastguard video sequence, it can be seen that the number of bits for MVs after temporal prediction decrease with increasing window size. This might appear counter-intuitive, however it may be explained as follows. When the temporal prediction is bad, then a small search window limits the result to be close to this poor prediction, instead of allowing the finding of a more accurate prediction. Although this small distance from the prediction results in fewer bits to code at the current level, not having a good prediction for the next (earlier) temporal level can significantly degrade the performance. This is actually clearly indicated by the results in the table of FIG. 15. All these results are from a 16 frame GOF with 4 levels of temporal decomposition. MV bits are shown for 5 frames, frame 8 that is filtered at level 3, frames 4 and 12 that are filtered at level 2, and frames 2 and 6 that are filtered at level 1. MVs of frame 8 are used to predict MVs of frames 4 and 12 and MVs of frame 4 are used to predict MVs of frames 2 and 6.

For frame 8, there is no temporal prediction, so the number of bits is the same in both cases. The number of bits is smaller for the ±4 window for frames 4 and 12, due to the smaller window size. However, the fact that this results in poor prediction for the frames at level 1 is indicated by the fact that the MV bits from frame 6 are much smaller for the ±16 window size. In fact, all the savings at level 2 are completely negated at level 1. However, when the motion is temporally correlated, then the use of this scheme can results in bit rate savings as well as improved PSNR.

An interesting extension of the idea to improve the results is possible. Since the predictions are desired to be as accurate as possible, a large window size needs to be started with at level 3, and then, decrease the window size across the different levels. For instance use a ±64 window size may be used at levels 3 and 2, and then decreased to a ±16 window size at level 1. This can lead to reduced bits along with improved PSNR.

All of the above discussion is for the UMCTF framework, where the motion estimation is performed on the original frames at all temporal levels. Adapting the above schemes for a lifting-based implementation, where motion estimation is performed at higher temporal levels on filtered L frames, may be difficult. The earlier described top-down embodiment can be adapted without difficulties, and it is expected that the results will be slightly better than for UMCTF, since the L frames are computed by taking into account the motion vectors estimated at lower temporal levels. However, for the bottom-up embodiment, some difficulties may be encountered, especially causality problems.

As shown in FIG. 16, in order to perform the bottom-up prediction embodiment during motion estimation, MV3 needs to be used to predict MV1 and MV2. However, if the estimation for MV3 needs to be performed on the filtered L frames, then MV1 and MV2 already need to have been estimated. This is because they are used during the creation of the L frames. So MV3 could not have been used for prediction during the estimation of MV1 and MV2. If instead, the motion estimation for MV3 is performed on unfiltered frames (i.e. the original frames), then bottom-up prediction during estimation can be used. However, the gains are likely to be worse than for the UMCTF scheme. Of course, bottom-up prediction embodiment can be used during the coding of the motion vectors (with no prediction during the estimation), however, as mentioned with regard to the top-down embodiment, there may exist some mismatch between the motion vectors at different levels.

Referring now to the flow chart of FIG. 17, there is shown a mixed, hybrid prediction and coding embodiment of the method of the present invention. In this embodiment, instead of using MVs from one decomposition level to predict MVs from other levels, a combination of MVs from different levels are used to predict other MVs. For example, a higher level MV(s) and forward MV(s) from the current level may be used to predict a backward MV(s). Using the simplified example of FIG. 3 again, step 400 includes determining MV1 and MV3, both of which may be determined conventionally by the motion estimation unit 132, at levels 0 (MV1) and level 1 (MV3) during motion estimation. In step 410, MV2 for level 0 is estimated or predicted as a refinement based on MV1 and MV3. The estimation of MV2 may be obtained by calculating the difference between MV1 and MV3. In step 420, the entropy encoding unit 160 (FIG. 2) entropy encodes MV1 and MV3. The method may end here or optionally in step 430, the entropy encoding unit 160 may also encode the refinements for MV2.

FIG. 18 shows an embodiment of a decoder which may be used for implementing the principles of the present invention, denoted by numeral 500. The decoder 500 includes an entropy decoding unit 510 for decoding the incoming bit-stream. During operation, the input bit-stream will be decoded according to the inverse of the entropy coding technique performed on the encoding side, which will produce wavelet coefficients that correspond to each GOF. Further, the entropy decoding produces the MVs including the MVs predicted in accordance with the present invention, and frame numbers that will be utilized later.

A significance decoding unit 520 is included in order to decode the wavelet coefficients from the entropy decoding unit 510 according to significance information. Therefore, during operation, the wavelet coefficients will be ordered according to the correct spatial order by using the inverse of the technique used on the encoder side. As can be further seen, a spatial recomposition unit 530 is also included to transform the wavelet coefficients from the significance decoding unit 520 into partially decoded frames. During operation, the wavelet coefficients corresponding to each GOF will be transformed according to the inverse of the wavelet transform performed on the encoder side. This will produce partially decoded frames that have been motion compensated temporally filtered according to the present invention.

As previously described, the motion compensated temporal filtering according to the present invention resulted in each GOF being represented by a number of H-frames and an A-frames. The H-frame being the difference between each frame in the GOP and the other frames in the same GOP, and the A-frame being either the first or last frame not processed by the motion estimation and temporal filtering on the encoder side. An inverse temporal filtering unit 540 is included to reconstruct the H-frames included in each GOP from the spatial recomposition unit 530, based on the MVs and frame numbers provided by the entropy decoding unit 510, by performing the inverse of the temporal filtering performed on the encoder side.

FIG. 19 shows an embodiment of a system in which the principles of the present invention may be implemented, denoted by numeral 600. By way of example, the system 600 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system 600 includes one or more video sources 610, one or more input/output devices 620, a processor 630, a memory 640 and a display device 650.

The video/image source(s) 610 may represent, e.g., a television receiver, a VCR or other video/image storage device. The source(s) 610 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 620, processor 630 and memory 640 communicate over a communication medium 650. The communication medium 650 may represent, e.g., a bus, a communication network, one or more internal connections of a circuit, circuit card or other device, as well as portions and combinations of these and other communication media. Input video data from the source(s) 610 is processed in accordance with one or more software programs stored in memory 640 and executed by processor 630 in order to generate output video/images supplied to the display device 650.

In particular, the software programs stored in memory 640 may include the method of the present invention, as described previously. In this embodiment, the method of the present invention may be implemented by computer readable code executed by the system 600. The code may be stored in the memory 640 or read/downloaded from a memory medium such as a CD-ROM or floppy disk. In other embodiments, hardware circuitry may be used in place of, or in combination with, software instructions to implement the invention.

The temporal MV prediction across multiple levels of the temporal decomposition, in the MCTF framework are necessary to efficiently code the additional sets of motion vectors that are generated within the UMCTF and lifting based MCTF frameworks. The MVs may be coded differentially, where the estimation process uses no prediction, or when the estimation also uses temporal prediction. Although the top-down embodiment is more efficient, it does not support temporal scalability, as with the bottom-up embodiment. When the motion is temporally correlated, the use of these schemes can reduce the MV bits by around 5-13% over no prediction and by around 3-5% over spatial prediction. Due to this reduction in MV bits, more bits can be allocated to the texture coding, and hence the resulting PSNR improves. PSNR improvements of around 0.1-0.2 dB at 50 Kbps have been observed for QCIF sequences. Importantly, the results indicate a great content dependence. In fact, for GOFs with temporally correlated motion, such schemes can significantly reduce the MV bits, and can improve the PSNR by up to 0.4 dB. Thus, the method of the invention can be used adaptively, based on the content and the nature of motion. The improvements achieved with the present invention are likely to be more significant when multiple reference frames are used, due to the greater temporal correlation that can be exploited. When MV prediction is used during motion estimation, different tradeoffs can be made between the bit rate, the quality and the complexity of the motion estimation.

While the present invention has been described above in terms of specific embodiments, it is to be understood that the invention is not intended to be confined or limited thereto. Therefore, the present invention is intended to cover various structures and modifications thereof included within the spirit and scope of the appended claims.

1. A method for encoding a video, the method comprising the steps of:
dividing (120) the video into a group of frames;
temporally filtering (134) the frames to provide at least first and second temporal decomposition levels;
determining (132, 200) at least two motion vectors from the first decomposition level;
estimating (210) at least one motion vector on the second temporal decomposition level as a refinement of the at least two motion vectors from the first temporal decomposition level; and
encoding (220) the at least two motion vectors from the first temporal decomposition level.

2. The method according to claim 1, further comprising the step of encoding (230) the estimated at least one motion vector of the second temporal decomposition level.

3. A method for encoding a video, the method comprising the steps of:
dividing (120) the video into a group of frames;
temporally filtering (134) the frames to provide at least first and second temporal decomposition levels;
determining (132, 300) at least one motion vector from the second temporal decomposition level;
estimating (310) at least two motion vectors on the first temporal decomposition level as a refinement of the at least one motion vector from the second temporal decomposition level; and
encoding (320) the at least one motion vector from the second temporal decomposition level.

4. The method according to claim 3, further comprising the step of encoding (330) the estimated at least two motion vectors of the first temporal decomposition level.

5. A method for encoding a video, the method comprising the steps of:
dividing (120) the video into a group of frames;
temporally filtering (134) the frames to provide at least first and second temporal decomposition levels;
determining (132, 400) at least one motion vector from the first temporal decomposition level and at least one motion vector from the second temporal decomposition level;
estimating (410) at least a second motion vector of the first temporal decomposition level as a refinement of the at least one motion vector from the first temporal decomposition level and the at least one motion vector from the second temporal decomposition level; and
encoding (420) the at least one motion vector from the first temporal decomposition level and the at least one motion vector from the second temporal decomposition level.

6. The method according to claim 5, further comprising the step of encoding (430) the estimated at least second motion vector of the first temporal decomposition level.

7. An apparatus for encoding a video comprising:
means (120) for dividing the video into a group of frames;
means (134) for temporally filtering the frames to provide at least first and second temporal decomposition levels;
means (132, 200) for determining at least two motion vectors from the first temporal decomposition level;
means (210) for estimating at least one motion vector on the second temporal decomposition level as a refinement of the at least two motion vectors from the first temporal decomposition level; and
means (220) for encoding the at least two motion vectors from the first temporal decomposition level.

8. The apparatus according to claim 7, further comprising means (230) for encoding the estimated at least one motion vector of the second temporal decomposition level.

9. A memory medium for encoding a video comprising:
code (120) for dividing the video into a group of frames;
code (134) for temporally filtering the frames to provide at least first and second temporal decomposition levels;
code (132, 200) for determining at least two motion vectors from the first temporal decomposition level;
code (210) for estimating at least one motion vector on the second temporal decomposition level as a refinement of the at least two motion vectors from the first temporal decomposition level; and
code (220) for encoding the at least two motion vectors from the first temporal decomposition level.

10. The memory medium according to claim 9, further comprising code (230) for encoding the estimated at least one motion vector of the second temporal decomposition level.

11. An apparatus for encoding a video comprising:
means (120) for dividing the video into a group of frames;
means (134) for temporally filtering the frames to provide at least first and second temporal decomposition levels;
means (132, 300) for determining at least one motion vector from the second temporal decomposition level;
means (310) for estimating at least two motion vectors on the first temporal decomposition level as a refinement of the at least one motion vector from the second temporal decomposition level; and
means (320) for encoding the at least one motion vector from the second temporal decomposition level.

12. The apparatus according to claim 11, further comprising means (330) for encoding the estimated at least two motion vectors of the first temporal decomposition level.

13. A memory medium for encoding a video comprising:
code (120) for dividing the video into a group of frames;
code (134) for temporally filtering the frames to provide at least first and second temporal decomposition levels;
code (132, 300) for determining at least one motion vector from the second temporal decomposition level;
code (310) for estimating at least two motion vectors on the first temporal decomposition level as a refinement of the at least one motion vector from the second temporal decomposition level; and
code (320) for encoding the at least one motion vector from the second temporal decomposition level.

14. The memory medium according to claim 13, further comprising code (330) for encoding the estimated at least two motion vectors of the first temporal decomposition level.

15. An apparatus for encoding a video comprising:
means (120) for dividing the video into a group of frames;
temporally filtering (134) the frames to provide at least first and second temporal decomposition levels;
means (132, 400) for determining at least one motion vector from the first temporal decomposition level and at least one motion vector from the second temporal decomposition level;
means (410) for estimating at least a second motion vector of the first temporal decomposition level as a refinement of the at least one motion vector from the first temporal decomposition level and the at least one motion vector from the second temporal decomposition level; and
means (420) for encoding the at least one motion vector from the first temporal decomposition level and the at least one motion vector from the second temporal decomposition level.

16. The apparatus according to claim 15, further comprising means (430) for encoding the estimated at least second motion vector of the first temporal decomposition level.

17. A memory medium for encoding a video comprising:
code (120) for dividing the video into a group of frames;
code (132, 400) for determining at least one motion vector from the first temporal decomposition level and at least one motion vector from the second temporal decomposition level;
code (410) for estimating at least a second motion vector of the first temporal decomposition level as a refinement of the at least one motion vector from the first temporal decomposition level and the at least one motion vector from the second temporal decomposition level; and
code (420) for encoding the at least one motion vector from the first temporal decomposition level and the at least one motion vector from the second temporal decomposition level.

18. The memory medium according to claim 17, further comprising code (430) for encoding the estimated at least second motion vector of the first temporal decomposition level.
